(19) United States
(12) Patent Application Publication
(10) Pub. No.: US 2010/0322125 A1
(43) Pub. Date: Dec. 23, 2010

(54) REMOTE CONTROL METHOD OF SENSOR NODE FOR LOW-POWER AND SENSOR NETWORK THEREFOR

(76) Inventors: In-Hwan Lee, Daejon (KR); Chang-Sub Shin, Daejon (KR); Sang-Gi Hong, Daejon (KR); Bong-Soo Kim, Daejon (KR); Cheol-Sig Pyo, Daejon (KR)

Correspondence Address: LADAS & PARRY LLP, 224 SOUTH MICHIGAN AVENUE, SUITE 1600, CHICAGO, IL, 60604, US

(21) Appl. No.: 12/517,897

(22) PCT Filed: Oct. 29, 2007
(86) PCT No.: PCT/KR07/05349

§ 371 Date: Jun. 5, 2009

(30) Foreign Application Priority Data
Dec. 8, 2006 (KR) 10-2006-0125124

(51) Int. Cl. H04W 84/02; G08C 17/00

(52) U.S. Cl. 370/311

(57) ABSTRACT

Provided are a remote control method of a sensor node for low-power and a sensor network therefor. The remote control method, including: generating an interrupt signal when a node receives a remote control signal from a corresponding micro radio frequency (RF) processor installed in a gateway; regenerating the interrupt signal when the node is not converted from a sleep mode to a wake-up mode; collecting sensing data by communicating with other nodes when the node is converted from the sleep mode to the wake-up mode; and converting from the wake-up mode into the sleep mode when the communication is completed.

### TECHNICAL FIELD

The present invention relates to a remote control method of a sensor node for low-power and a sensor network therefor; and, more particularly, to a remote control method of a sensor node for low-power that can reduce power consumption of a sensor network entirely by converting a mode of a remote node from a sleep mode to a wake-up mode based on a remote control signal transmitted from a micro radio frequency (RF) processor when sensing data are needed due to an emergency situation in the sensor network.

This work was supported by the Information Technology (IT) research and development program of the Korean Ministry of Information and Communication (MIC) and the Korean Institute for Information Technology Advancement (IITA) [2005-S-038-02, “Development of UHF RF-ID and Ubiquitous Networking Technology”].

### BACKGROUND ART

Since, there are increasing demands for diverse applications of sensors, the research on a controlling and sensing technology through a wireless network has actively progressed.

In a conventional sensor network, a desired operation is performed by operating an actuator based on information acquired by a sensor.

Hereinafter, a general sensor network will be described.

FIG. 1 is a diagram illustrating a general sensor network.

As shown in FIG. 1, the general sensor network includes a sensor node 105 or 106, a sink node 104, and a gateway 103.

The sensor node 105 or 106 senses environmental information, e.g., a physical quantity on temperature, rate of flow, air pressure, vibration and motion of an object, and transmits the environmental information to the sink node 104. The sink node 104 collects information sensed by the sensor node 105, and transmits the information to the gateway 103 based on IEEE 802.15.4.

The gateway 103 receives the collected sensing information from the sink node 104 based on IEEE 802.11 or IEEE 802.3, and transmits the sensing information to a network 100 such as Broadband Convergence Network (BcN) through a WLAN AP 102 and a router 101.

Detailed configuration of the sensor network may differ according to the kind of required services.

FIG. 2 is a block diagram illustrating a node of a general sensor network.

As shown in FIG. 2, the node of the general sensor network—which includes the sensor node 105 and 106, the sink node 104 and the gateway 103—includes a Radio Frequency (RF) module 210 for supporting RF communication, and a processor module 220, which cooperates with the RF module 210 and processes data.

The RF module 210 includes an antenna 211, an analog-to-digital converting (ADC) unit 212, a digital-to-analog converting (DAC) unit 213, a demodulating unit 214, a modulating unit 215 and a digital intermediate frequency (IF) unit 216.

The antenna 211 transmits and/or receives signals. The ADC unit 212 converts an analog signal into a digital signal. The DAC unit 213 converts a digital signal into an analog signal. The demodulating unit 214 demodulates a received signal. The modulating unit 215 modulates a transmission signal. The digital IF unit 216 includes a transmission/reception buffer 2161 and transmits an interrupt signal to the processor module 220.

The processor module 220 includes an interrupt processing unit 221, a signal peripheral interface (SPI) communication unit 222, a timer/counter unit 223, an ADC unit 224, a universal asynchronous receiving/transmitting (UART) unit 225, a synchronous dynamic random access memory (SDRAM) 226 and a flash memory 227.

The interrupt processing unit 221 processes an interrupt signal transmitted from the RF module 210. The SPI communication unit 222 makes it possible to transmit and/or receive synchronous data to/from the RF module 210. The timer/counter unit 223 compares a synchronization time difference between nodes. The ADC unit 224 converts an analog signal into a digital signal. The UART unit 225 processes serial communication. The SDRAM 226 and the flesh memory 227 function as a memory.

Requests for wirelessly receiving data via a sensor are increasing. In the ongoing research technology, due to the characteristics of a sensor node, a battery is used as a power source, which results in a distance limitation. Accordingly, entire power consumption of the sensor node increases and the battery should be changed frequently, increasing cost and time.

Recently, keeping pace with the development of small low-power sensors, the field of applying a technology of connecting low-power sensor nodes through a network has diversified. Thus, low-power issue of the sensor nodes has become an important problem in constructing the sensor network.

Generally, power consumption of the sensor node is proportional to wake-up time of the sensor node. However, in the conventional sensor network technology, if a sleep mode of the sensor node is long, the sink node or the gateway cannot receive the data at desired time. Also, as applications in which the sensor nodes are controlled by the remote node or the sink node have diversified, power consumption has increased.

### DISCLOSURE OF INVENTION

### Technical Problem

An embodiment of the present invention is directed to providing a remote control method of a sensor node for low-power that can reduce power consumption of a sensor network entirely by converting a mode of a remote node from a sleep mode to a wake-up mode based on a remote control signal transmitted from a micro RF processor when sensing data are needed due to an emergency situation in the sensor network.

Other objects and advantages of the present invention can be understood by the following description, and become apparent with reference to the embodiments of the present invention. Also, it is obvious to those skilled in the art of the present invention that the objects and advantages of the present invention can be realized by the means as claimed and combinations thereof.

### Technical Solution

In accordance with an aspect of the present invention, there is provided a remote control method for a sensor network having a micro radio frequency (RF) processor for each node, including: generating an interrupt signal when a node receives a remote control signal from a corresponding micro RF processor installed in a gateway; re-generating the interrupt signal when the node is not converted from a sleep mode to a wake-up mode; collecting sensing data by communicating with other nodes when the node is converted from the sleep mode to the wake-up mode; and converting from the wake-up mode into the sleep mode when the communication is completed.

In accordance with another aspect of the present invention, there is provided a sensor network having a gateway, a sink node and a sensor node, including: a first micro radio frequency (RF) processor having a amplifier for transmitting a remote control signal into the sink node and/or the sensor node operated in a sleep mode, wherein the first micro RF processor is installed in the gateway; and a second micro RF processor for long-distance communicating with the first micro RF processor, wherein the second micro RF processor is installed in the sink node and/or the sensor node.

### ADVANTAGEOUS EFFECTS

In the present invention, a sensor node, a sink node and a gateway of a sensor network include low-power consumption micro RF processors. Through the micro RF processors, a wake-up signal is transmitted to remote nodes when data is needed due to emergency situation. Therefore, based on the received signal from the micro RF processor, nodes in a sleep mode generate an interrupt and convert from the sleep mode to a wake-up mode.

The present invention can reduce power consumption by operating an amplifier included in the micro RF processor when the amplifier is only used for transmission.

The present invention can be used in various applications such as military and firefighting applications by operating the remote nodes, and can implement effective sensor network by constructing low-power sensor network.

### BRIEF DESCRIPTION OF THE DRAWINGS

FIG. 1 is a diagram illustrating a general sensor network.

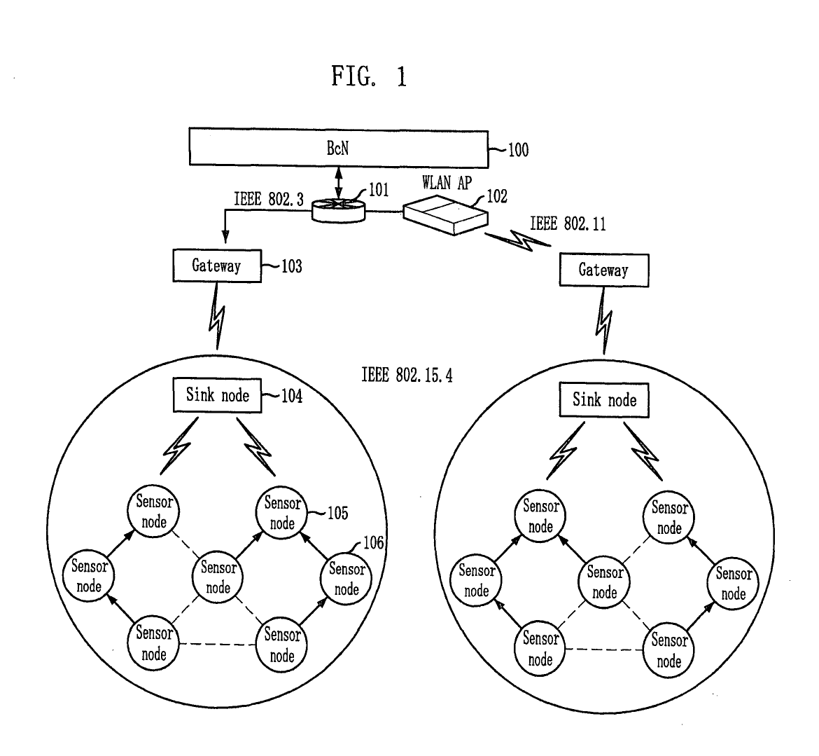

FIG. 2 is a diagram illustrating each node of a general sensor network.

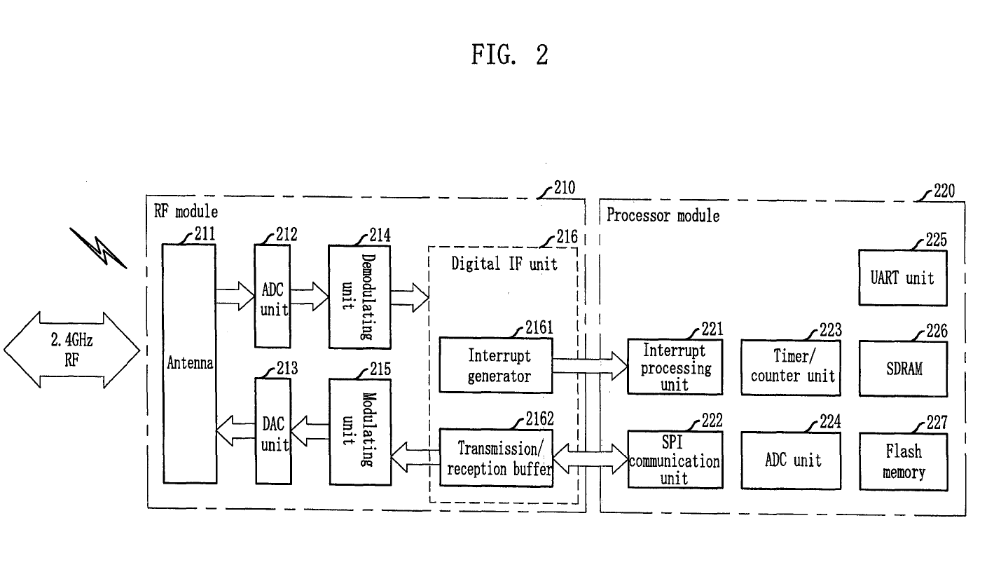

FIG. 3 is a diagram illustrating a sensor network for low-power in accordance with an embodiment of the present invention.

FIG. 4 is a detailed diagram of FIG. 3 in accordance with an embodiment of the present invention.

FIG. 5 is a flowchart showing a remote control method of a sensor node for low-power in accordance with an embodiment of the present invention.

### BEST MODE FOR CARRYING OUT THE INVENTION

The advantages, features and aspects of the invention will become apparent from the following description of the embodiments with reference to the accompanying drawings, which is set forth hereinafter, and thus the invention will be easily carried out by those skilled in the art to which the invention pertains. Also, when it is considered that detailed description on a related art may obscure the points of the present invention unnecessarily in describing the present invention, the description will not be provided herein. Hereinafter, specific embodiments of the present invention will be described with reference to the accompanying drawings.

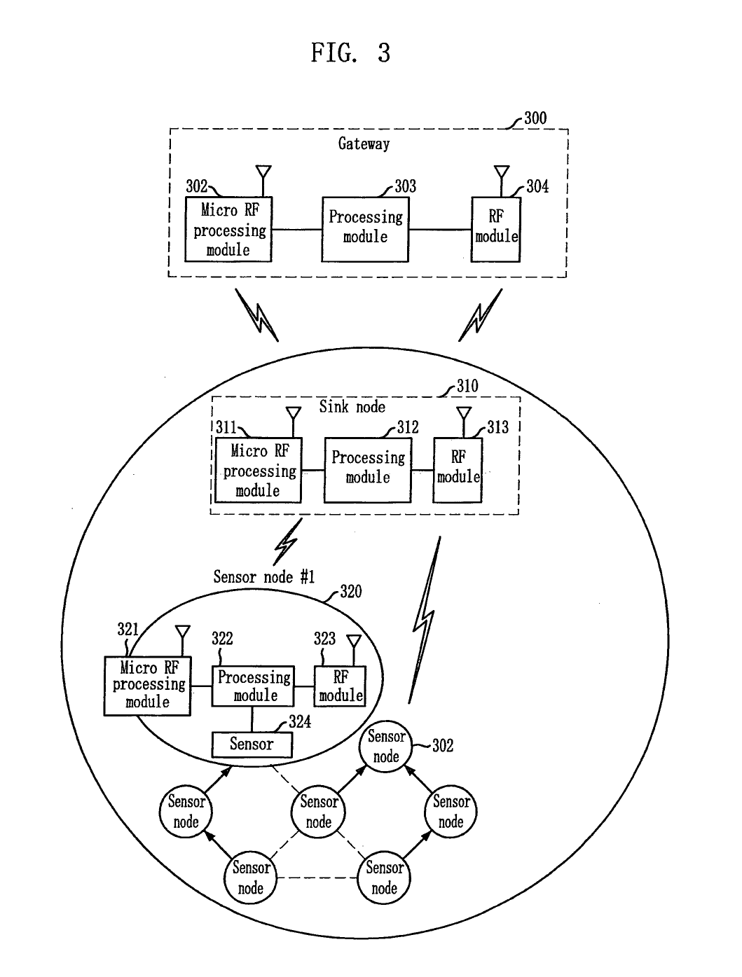

FIG. 3 is a diagram illustrating a sensor network for low-power in accordance with an embodiment of the present invention.

As shown in FIG. 3, the sensor network of the present invention includes a gateway 300, a sink node 310 and a sensor node 320. Particularly, micro RF processing modules 302, 311, 321 outputting high-power are further included in the sensor network.

Herein, the gateway 300 includes the micro RF processing module 302, a processing module 303 and a RF module 304. Also, the sink node 310 includes the micro RF processing module 311, a processing module 312 and a RF module 313. Also, the sensor node 320 includes the micro RF processing module 321, a processing module 322, a RF module 323 and a sensor 324.

The sensor network is mostly used for short-distance communication. If a control from long-distance is possible, the sensor network will be used in various other applications.

The gateway 300 performs a remote control for operating long-distance sink node 310 or sleep mode sensor node 320 by using the micro RF processing module 302. That is, the gateway 300 lets the sink node 310 or the sensor node 320 in the sleep mode for a long time so that the sensor network can operate in low-power.

When necessary, the sink node 310 or the sensor node 320 have the micro RF processing modules 311 and 321; and when a network for operating a remote node or a sleep mode node is constructed, the network operated in low-power can be implemented.

The micro RF processing module 302 outputs remote control signals to remote nodes. If the micro RF processing module included in the sink node or the sensor mode receives the remote control signal, an interrupt signal is transmitted to a micro controller unit (MCU) of self node, and the sleep mode can be converted into a wake-up mode.

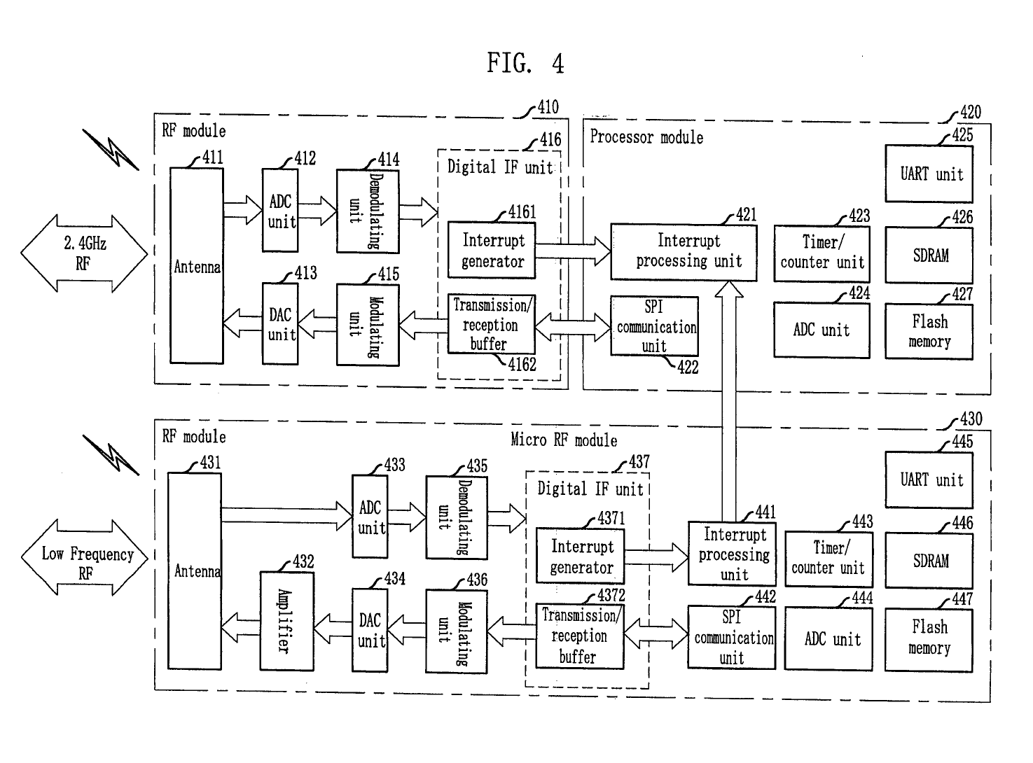

FIG. 4 is a detailed diagram of FIG. 3 in accordance with an embodiment of the present invention.

A node for remote control includes a RF module 410, a processor module 420 and a micro RF processing module 430. Herein, the RF module 410 includes an antenna 411, an ADC unit 412, a DAC unit 413, a demodulating unit 414, modulating unit 415 and a digital intermediate frequency (IF) unit 416. The digital IF unit for transmitting an interrupt to the processing module 420 includes an interrupt generator 4161 and a transmission/reception buffer 4162.

Also, the processing module 420 includes an interrupt processing unit 421, a signal peripheral interface (SPI) communication unit 422, timer/counter unit 423, an ADC unit 424, a universal asynchronous receiving/transmitting (UART) unit 425, a synchronous dynamic random access memory (SDRAM) 426, and a flash memory 427. The interrupt processing unit 421 processes interrupt signals transmitted from the RF module 410 and the micro RF processing module 430.

The micro RF processing module 430, formed by integrating the processing module and the RF module, further includes an amplifier 432 for outputting RF signal to a remote place.

In other words, the micro RF processing module 430 includes an antenna 431, the power amplifier 432, a ADC unit 433, a DAC unit 434, a demodulating unit 435, a modulating unit 436, a digital IF unit 437, an interrupt processing unit 441, a SPI communication unit 442, a timer/counter unit 443, a ADC unit 444, a UART unit 445, a SDRAM 446 and flash memory 447. The digital IF unit 437 for transmitting an interrupt to the processing unit 441 includes an interrupt generator 4371 and a transmission/reception buffer 4372. The interrupt processing unit 441 processes the interrupt transmitted from the interrupt generator 4371 and transmits the interrupt to the processing module 420.

Because of a low-power micro RF processing module 430, the gateway 300, the sink node 310 and the sensor node 320 do not affect power consumption. Also, sleep mode can be more stably used than the other general nodes.

In the gateway 300, in order to support long distance, the micro RF processing module 430 expands a transmission distance via the amplifier 432. Because the power consumption of the amplifier 432 can increase, the amplifier 432 operates only when it needs to. The gateway 300 outputs the remote control signal to long-distance apart sink node 310 or the sensor node 320. Also, the gateway 300 is installed at places where commercial power is available.

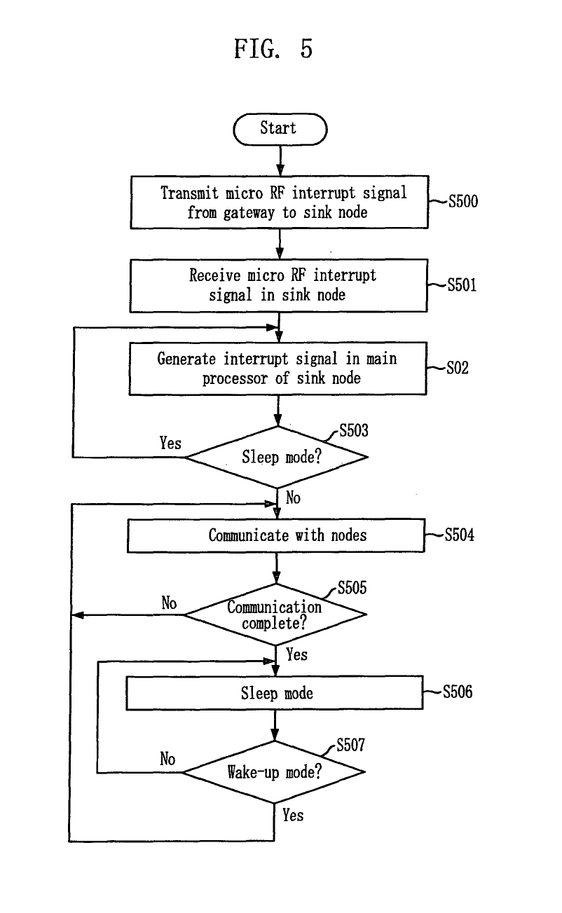

FIG. 5 is a flowchart showing a remote control method of a sensor node for low-power in accordance with an embodiment of the present invention.

The remote control method of a sensor network having a sensor node or sink node in a sleep mode will be described hereinafter.

When the gateway 300 collects data from each node of the sensor network in emergency, a micro RF processing module included in the gateway 300 transmits a remote control signal to the sink node 310 and/or the sensor node 320 at step S500. The emergency is either when the gateway 300 collects sensing data by wake-up only the sink node 310 or when the gateway 300 collects sensing data by waking up both the sink node 310 and the sensor node 320.

The sink node 310 receives the remote control signal from the gateway 300 at step S501. Then, the sink node 310 generates an interrupt signal by the processing module 312 based on the remote control signal (micro RF interrupt signal) transmitted from the gateway 300 at step S502.

At step S503, the sink node 310 checks if it is the sleep mode. If the sink node 310 maintains the sleep mode in spite of the interrupt signal, repeat the step S502 to generate the interrupt signal.

If the sink node 310 is not the sleep mode, the sink node performs data communication with neighbor nodes at step S504.

The data communication is completed at step S505, and the sink node 310 is converted into the sleep mode at step S506. If the sink node 310 or the sensor node 320 is not wake-up mode, maintain the sleep mode at step S507.

The above described method according to the present invention can be embodied as a program and be stored on a computer readable recording medium. The computer readable recording medium is any data storage device that can store data which can be read by the computer system. The computer readable recording medium includes a read-only memory (ROM), a random-access memory (RAM), a CD-ROM, a floppy disk, a hard disk and an optical magnetic disk.

The present application contains subject matter related to Korean Patent Application No. 2006-0125124, filed in the Korean Intellectual Property Office on Dec. 8, 2006, the entire contents of which is incorporated herein by reference.

While the present invention has been described with respect to certain preferred embodiments, it will be apparent to those skilled in the art that various changes and modifications may be made without departing from the scope of the invention as defined in the following claims.

1. A remote control method for a sensor network having a micro radio frequency (RF) processor for each node, comprising:
generating an interrupt signal when a node receives a remote control signal from a corresponding micro RF processor installed in a gateway;
regenerating the interrupt signal when the node is not converted from a sleep mode to a wake-up mode;
collecting sensing data by communicating with other nodes when the node is converted from the sleep mode to the wake-up mode; and
converting from the wake-up mode into the sleep mode when the communication is completed.

2. A sensor network having a gateway, a sink node and a sensor node, comprising:
a first micro radio frequency (RF) processor having a amplifier for transmitting a remote control signal into the sink node and/or the sensor node operated in a sleep mode, wherein the first micro RF processor is installed in the gateway; and
a second micro RF processor for long-distance communicating with the first micro RF processor, wherein the second micro RF processor is installed in the sink node and/or the sensor node.

3. The sensor network of claim 2, wherein the amplifier is not supplied power when the amplifier does not operate.
